(19) United States
(12) Patent Application Publication
(10) Pub. No.: US 2020/0041618 A1
(43) Pub. Date: Feb. 6, 2020

(54) Matrix Light Source and Detector Device for Solid-State Lidar

(71) Applicant: Infineon Technologies AG, Neubiberg (DE)

(72) Inventors: Georg Pelz, Ebersberg (DE); Norbert Elbel, Rosenheim (DE)

(21) Appl. No.: 16/052,862

(22) Filed: Aug. 2, 2018

(51) Int. Cl. G01S 7/481; G01S 17/66; G01S 7/487; G01S 7/486

(52) U.S. Cl. CPC G01S 7/4817; G01S 7/4863; G01S 7/487; G01S 17/66

(57) ABSTRACT

An electronic system includes a pixelated light source having a plurality of individually controllable pixels, a controller operable to control the pixelated light source, a photosensor configured to detect light signals emitted from the pixelated light source, and an analysis unit configured to recognize objects with different properties that pass in range of the pixelated light source and the photosensor, based on the light signals detected by the photosensor. Corresponding object recognition and material analysis methods are also described.

### BACKGROUND

Ranging and object recognition are standard tasks in many applications such as road traffic, industrial environments, household or building navigation, etc. One approach for ranging and object recognition is light detection and ranging (LIDAR). LIDAR is a technique whereby light is emitted and reflections caused by objects in ranging distance are detected. The time of flight is taken as a measure for the distance between the LIDAR system and the detected object.

One type of LIDAR system implements the scan using a rotating mirror or a micro-mirror, which is tilted. This type of LIDAR system is costly and requires a lot of space due to the moving parts. Another type of LIDAR system uses a vertical line of light sources and a horizontal line of detectors. This type of LIDAR system does not have moving parts, but is not 2-dimensional and uses additional optics such as a diffuser lens to diffuse the emitted light and create a narrow, vertical beam of laser light which projects onto the observation area.

Hence, there is a need for a more cost-effective and less complex LIDAR system.

### SUMMARY

According to an embodiment of a light detection and ranging (LIDAR) system, the LIDAR system comprises: a pixelated light source comprising a two-dimensional array of individually controllable pixels; a controller operable to individually control each pixel of the two-dimensional array, to emit independently controlled light beams from the pixelated light source; one or more optical components aligned with the pixelated light source and configured to direct the independently controlled light beams emitted from the pixelated light source in different directions and/or to spread the independently controlled light beams; and a photosensor configured to detect one or more of the independently controlled light beams reflected off an object in range of the pixelated light source and in a direction toward the photosensor. The light source may be any type of electromagnetic radiation source, including but not limited to visible light, infrared, ultraviolet light or even x-rays.

The photosensor may be integrated with the pixelated light source in a same semiconductor die or in a same package. The photosensor may thus provide a compact arrangement, e.g. a single component which may only require a single power supply plugged in and provides a common I/O interface.

Separately or in combination, the photosensor may be realized by a subset of the individually controllable pixels of the pixelated light source which are not operated as light emitters. The photosensor may thus provide an efficient use of the individually controllable pixels of the pixelated light source.

Separately or in combination, the controller may be operable to change the subset of individually controllable pixels used to implement the photosensor so that the pixels used for light emission and the pixels used for light detection change over time. The photosensor may thus provide an efficient yet flexible use of the individually controllable pixels of the pixelated light source.

Separately or in combination, each pixel of the pixelated light source may be operated alternately in light emission mode and light detection mode.

Separately or in combination, the photosensor may be a non-pixelated single photosensor or a pixelated array of photosensors spaced apart from and aligned with the independently controlled light beams from the pixelated light source. A non-pixelated single photosensor together with a pixelated light source may provide sufficient spatial resolution for some applications and thus may provide a cost-efficient solution for those applications. A pixelated array of photosensors may provide a high resolution light detection and ranging system wherein spatial information from the light sources as well as from the photosensors may be combined for analyses purposes.

Separately or in combination, the controller may be operable to perform a first-resolution scan of the complete range of the light detection and ranging system using a subset of pixels of the two-dimensional array to detect one or more object candidate using a first pixel-to-area-ratio, and perform a second-resolution scan of one or more respective regions of the complete range of the light detection and ranging system in which the one or more object candidates have been detected using a second subset of the pixels of the two-dimensional array which emit light in the direction of the one or more object candidates using a second pixel-to-area-ratio. A light detection and ranging system with the above mentioned controller may operate in an energy-efficient way while providing a required resolution if only those of the individually controllable pixels are operated which are located in a region of interest identified in a first scan. The region of interest may be a subset of the complete range or the complete range depending on the one or more object candidates detected in the scan.

Separately or in combination, if one of the one or more object candidates is confirmed as the object, the second subset of pixels may be automatically adapted to cover an area of a predicted movement track of the object.

Separately or in combination, the controller may be operable to periodically activate the first subset of the pixels of the two-dimensional array to detect new object candidates which enter the complete range of the light detection and ranging system.

Separately or in combination, the controller may be operable to periodically activate the first subset of the pixels of the two-dimensional array every 50 to 100 milliseconds to detect new object candidates which enter the range of the light detection and ranging system.

Separately or in combination, the controller may be operable to simultaneously activate a subset of the pixels of the two-dimensional array to verify weak reflections or spurious signals detected by the photosensor in range or near the subset of pixels.

Separately or in combination, the LIDAR system may further comprise an analysis unit operable to calculate a distance between the object and the light detection and ranging system based on the one or more of the independently controlled light beams detected by the photosensor.

According to an embodiment of a method of operating a LIDAR system which includes a photosensor and a pixelated light source comprising a two-dimensional array of individually controllable pixels, the method comprises: individually controlling each pixel of the two-dimensional array, to emit independently controlled light beams from the pixelated light source; directing the independently controlled light beams emitted from the pixelated light source in different directions and/or spreading the independently controlled light beams; and detecting one or more of the independently controlled light beams reflected off an object in range of the pixelated light source and in a direction toward the photosensor.

Separately or in combination, the method may further comprise: realizing the photosensor by a subset of the individually controllable pixels of the pixelated light source which are not operated as light emitters.

Separately or in combination, the method may further comprise: changing the subset of individually controllable pixels used to implement the photosensor so that the pixels used for light emission and the pixels used for light detection change over time.

Separately or in combination, changing the subset of individually controllable pixels used to implement the photosensor may comprise operating each pixel of the pixelated light source alternately in light emission mode and light detection mode.

Separately or in combination, the method may further comprise: performing a first-resolution scan of the complete range of the light detection and ranging system using a subset of pixels of the two-dimensional array to detect an object candidate using a first pixel-to-area-ratio; and performing a second-resolution scan of a region of the complete range of the light detection and ranging system in which the object candidate has been detected using a second subset of the pixels of the two-dimensional array which emit light in the direction of the object candidate using a second pixel-to-area-ratio.

Separately or in combination, the method may further comprise: periodically activating the first subset of the pixels of the two-dimensional array to detect new object candidates which enter the range of the light detection and ranging system.

Separately or in combination, the method may further comprise: simultaneously activating a subset of the pixels of the two-dimensional array to verify weak reflections or spurious signals detected by the photosensor in range or near the subset of pixels.

Separately or in combination, the method may further comprise: calculating a distance between the object and the light detection and ranging system based on the one or more of the independently controlled light beams detected by the photosensor.

Those skilled in the art will recognize additional features and advantages upon reading the following detailed description, and upon viewing the accompanying drawings.

### BRIEF DESCRIPTION OF THE FIGURES

The elements of the drawings are not necessarily to scale relative to each other. Like reference numerals designate corresponding similar parts. The features of the various illustrated embodiments can be combined unless they exclude each other. Embodiments are depicted in the drawings and are detailed in the description which follows.

FIG. 1 illustrates a block diagram of an embodiment of a light detection and ranging (LIDAR) system having an array of individually controllable light sources in combination with a photosensor and an intelligent control method for implementing ranging and object recognition functionality.

FIG. 2 illustrates an embodiment of the LIDAR system in which the photosensor is realized by a subset of the individually controllable pixels of the pixelated light source.

FIG. 3 illustrates an embodiment of the LIDAR system in which the pixelated light source and the photosensor share the same array of pixels and the controller allocates some of the pixels for light emission and other ones of the pixels for light detection.

FIG. 4 illustrates an embodiment of a multi-resolution object candidate scan method implemented by the controller of the LIDAR system.

FIGS. 5 through 7 illustrate various implementation embodiments for the pixelated light source and photosensor components of the LIDAR system.

### DETAILED DESCRIPTION

The embodiments described herein provide a light detection and ranging (LIDAR) system which has a pixelated light source, a photosensor and an intelligent control method for implementing ranging and object recognition functionality. The LIDAR system described herein includes a two-dimensional array of individually controllable pixels for producing light beams which can be independently controlled. The LIDAR system scans an observation area in 2-dimensions without using a rotating mirror or similar moving parts. The LIDAR system may track a detected object via a high-resolution scan that uses more, but not necessarily all, of the available pixels included in the two-dimensional array of individually controllable pixels. The LIDAR system may implement ranging based on reflections detected by the photosensor. The LIDAR system may illuminate only pixels of interest, thereby increasing energy efficiency of the system. The LIDAR system may randomly access individual ones of the pixels since the pixels are individually controllable. This way, the light beams emitted by the LIDAR system may be accessed in a random fashion and iterative complete scans of the full space in question are not required to detect an object in-range of the LIDAR system. The LIDAR system may be used in various applications having a need for ranging and object recognition. A few non-limiting examples include in-building navigation equipment such as service robots, automatic parking of vehicles, workpiece detection and orientation during fabrication, to name a few. The LIDAR system is described next in more detail.

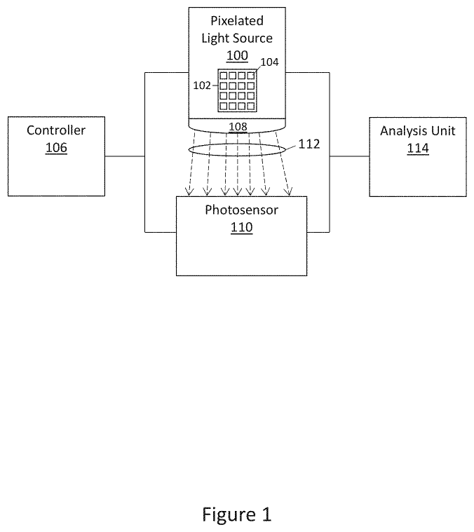

FIG. 1 illustrates an embodiment of a LIDAR system having ranging and object recognition functionality. The LIDAR system includes a pixelated light source 100 having a two-dimensional array 102 of individually controllable pixels 104, a controller 106, one or more optical components 108 aligned with the pixelated light source 100, and a photosensor 110. The two-dimensional array 102 is illustrated as a 4×4 array of pixels 104 in FIG. 1 for ease of illustration only. In general, the two-dimensional array 102 is an N×M array of individually controllable pixels 104 where N and M are each integers greater than 1. Each pixel 104 may be individually accessed at any time, by the controller 106 applying the appropriate electrical signals to the pixelated light source 100.

The term “pixel” as used herein means the smallest controllable element of a light source or photosensor. Each pixel may be capable of emitting light, detecting light or both emitting and detecting light at different points in time. That is, a pixel may be configured just as a light emitter, just as a light detector, or as a light emitter over some durations and as a light detector over other durations. For example, LEDs (light emitting diodes) can be configured to emit light or detect light. In general, the pixelated light source 100 may be any type of electromagnetic radiation source, including but not limited to visible light, infrared, ultraviolet light or even x-rays. The photosensor 110 may or may not be pixelated. If the photosensor 110 is not pixelated, the controller 106 may operate the photosensor 100 in time-multiplex to provide spatial resolution. The pixelated light source 100 and the photosensor 110 may be monolithically integrated in the same semiconductor die, integrated in the same package, implemented as discrete components, etc. The pixelated light source 100 and the photosensor 110 may share the same array 102 of pixels 104. For example, first ones of the individually controllable pixels 104 may be used to implement the light source 100, whereas second ones of the individually controllable pixels 104 may be used to implement the photosensor 110. Alternately, the pixelated light source 100 and the photosensor 110 may be implemented with separate pixel arrays if the photosensor 110 is pixelated.

The controller 106 individually controls each pixel 104 of the two-dimensional array 102, to emit independently controlled light beams 112 from the pixelated light source 100. The controller 106 may be a processor such as a microprocessor, a processor core, etc., a microcontroller, an ASIC (application-specific integrated-circuit), etc. The controller 106 is designed, programmed and/or hardwired to control the pixelated light source 100 and the photosensor 110 in accordance with the ranging and object recognition embodiments described herein. For example, the controller 106 may determine which ones of the individually controllable pixels 104 to illuminate and in what sequence. In the case of the individually controllable pixels 104 being used to implement both the light source 100 and the photosensor 110, the controller 106 determines which ones of the individually controllable pixels 104 are used to implement the light source 100 and which ones of the individually controllable pixels 104 are used to implement the photosensor 110. The controller 106 may change the use of an individually controllable pixel 104 from light emitting to light detecting, or from light detecting to light emitting. The controller 106 may determine which pixels 104 are active and which ones are not. Various control aspects implemented by the controller 106 are explained in more detail below, in accordance with the corresponding embodiment being described.

The one or more optical components 108 aligned with the pixelated light source 100 direct the independently controlled light beams 112 emitted from the pixelated light source 100 in different directions and/or spread the independently controlled light beams 112 to create a observation area for ranging and object recognition. The one or more optical components 108 may include a lens aligned with the two-dimensional array 102 of individually controllable pixels 104 for directing and/or shaping the light beams. This way, the pixelated light source 100 with the aid of the one or more optical components 108 may emit light beams in defined different directions. Any single pixel 104 in the two-dimensional array 102 may have a related direction. The wavelength of the independently controlled light beams 112 emitted by the two-dimensional array 102 of individually controllable pixels 104 may be in the visible spectrum, the IR (infrared) spectrum or the UV (ultraviolet) spectrum, for example.

The photosensor 110 detects one or more of the independently controlled light beams 112 reflected off an object located in the observation area of the LIDAR system and which propagate in a direction toward the photosensor 110. The reflections may be detected by non-illuminated ones of the pixels 104 which are operated as light sensors by the controller 106, in the case of the photosensor 110 and the pixelated light source 100 sharing the same two-dimensional array 102 of pixels 104. The reflections instead may be detected by a separate photosensor sensor device nearby and which forms the photosensor 110. The one or more optical components 108 may include a lens aligned with the photosensor 110 for aggregating reflected light which is detected by the photosensor 110 and analysed by the analysis unit 114.

The LIDAR system may further include an analysis unit 114 for analysing the output of the photosensor 110. The analysis unit 114 may initially detect an object located within the observation area of the LIDAR system, based on the photosensor output. The LIDAR system may use a subset of the pixels 104 to track movement of the object. This way, the entire range of the LIDAR system need not be used to track an object. The LIDAR system may emit all light beams periodically, e.g. every 50 or 100 ms, to detect new objects located within the observation area of the LIDAR system. Doing so reduces the timing requirements for transmitting and receiving ‘optical pings’, as fewer optical pings are necessary for new object detection implemented by the analysis unit 114.

In one embodiment, the analysis unit 114 calculates the distance between a detected object and the LIDAR system based on the independently controlled light beam(s) 112 detected by the photosensor 110. For example, the analysis unit 114 may calculate the distance (d) as d=c*t/2, where c is the speed of light and t is the time between light emission and detection. The analysis unit 114 may be included and/or associated with the controller 106. For example, in the case of a processor-based controller, the controller 106 may be programmed to implement the analysis unit 114 functionality described herein. In the case of an ASIC-based controller, the controller 106 may be designed and/or hardwired to implement the analysis unit functionality described herein. The analysis unit 114 instead may be a separate component from the controller 106.

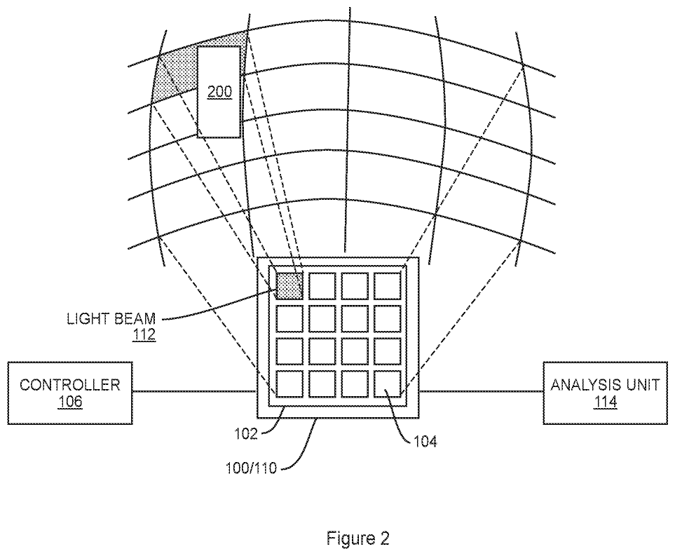

FIG. 2 illustrates an embodiment of the LIDAR system in which the photosensor 110 is realized by a subset of the individually controllable pixels 104 of the pixelated light source 100 which are not operated as light emitters. According to this embodiment, the pixelated light source 100 and the photosensor 110 share the same two-dimensional array 102 of individually controllable pixels 104. The controller 106 allocates some of the pixels 104 for light emission and other ones of the pixels 104 for light detection. The controller 106 may change the light emission/light detection pixel assignments. That is, a pixel 104 may be used for light emission during some periods of time and for light detection during other periods of time. For example, a pixelated Si/LED (light emitting diode) hybrid die with a two-dimensional array 102 of pixels 104 could be used. Such a die has pixels which can be controlled to either emit light or detect light. The pixelated light source 100 and the photosensor 110 may or may not be monolithically integrated in the same semiconductor die.

According to the embodiment illustrated in FIG. 2, the subset of individually controllable pixels 104 used to implement the photosensor 110 are configured to detect light reflections from a reflective surface of an in-range object 200. The analysis unit 114 performs ranging and object recognition, based on the light signals detected by the subset of individually controllable pixels 104 used to implement the photosensor 110. Spatial resolution can be improved by operating each pixel 104 of the two-dimensional array 102 alternately in light emission mode and light detection mode. The controller 106 may simultaneously activate a subset of the pixels 104 (e.g. 4 pixels, 9 pixels, etc.) to verify weak reflections or spurious signals detected by the photosensor 110.

FIG. 2 also shows an exemplary object 200 within the observation area of the LIDAR system. One light beam/pixel illuminates the in-range object 200 in FIG. 2. The photosensor 110 detects the light beam 112 which reflects off the in-range object 200 in a direction toward the photosensor 110. The analysis unit 114 performs ranging and/or object recognition based on the photosensor output. For example, the analysis unit 114 may calculate the distance between the detected in-range object 200 and the LIDAR system based on the independently controlled light beam(s) 112 detected by the photosensor 110,

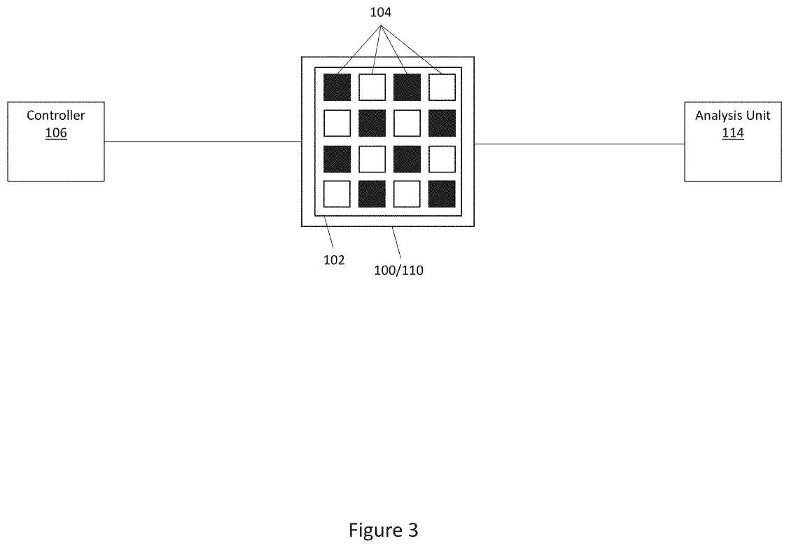

FIG. 3 illustrates an embodiment in which the pixelated light source 100 and the photosensor 110 share the same tow-dimensional array 102 of individually controllable pixels 104, and the controller 106 allocates some of the pixels 104 for light emission and other ones of the pixels 104 for light detection. Desired light patterns may be realized by the controller 106 applying the appropriate electrical signals to the pixelated light source 100. The light emission/light detection pixel assignment is illustrated as a checkerboard pattern in FIG. 3. However, the controller 106 may assign the pixels 104 for light emission or light detection in any desired pattern by applying the corresponding electrical signals to the pixelated light source 100. The controller 106 may change the subset of individually controllable pixels 104 used to implement the photosensor 110 so that the pixels 104 used for light emission and the pixels 104 used for light detection change over time. In one embodiment, each pixel 104 of the pixelated light source 100 is operated alternately in light emission mode and light detection mode to increase spatial resolution.

In another embodiment of the LIDAR system, the photosensor 110 is a non-pixelated single photosensor or a pixelated array of photosensors spaced apart from and aligned with the independently controlled light beams 112 emitted from the pixelated light source 100. The one or more optical components 108 may be used to align the separate photosensor 110 with the independently controlled light beams 112 emitted from the pixelated light source 100.

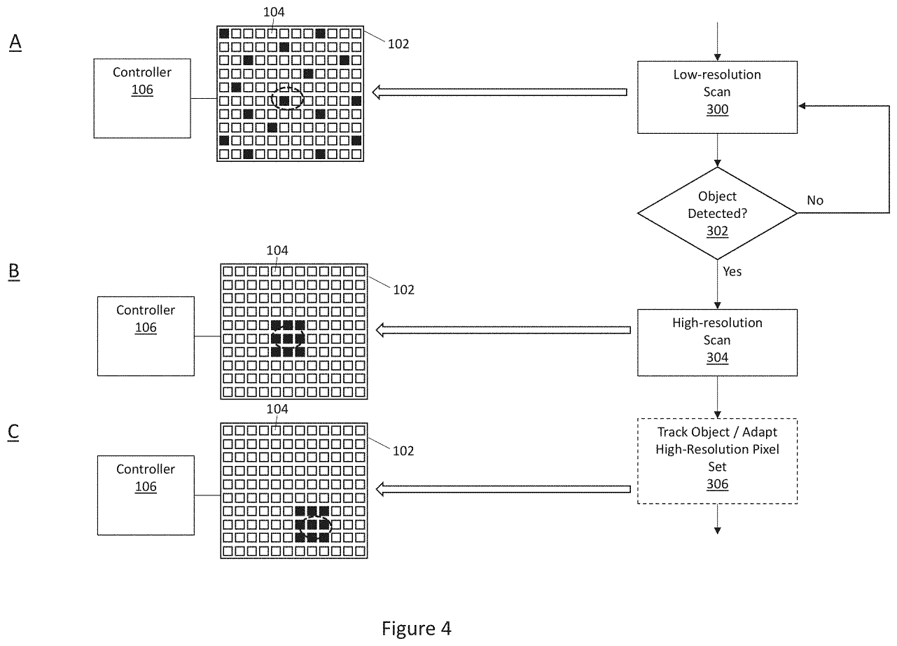

FIG. 4 illustrates an embodiment of a multi-resolution object candidate scan method implemented by the controller 106 of the LIDAR system. According to this embodiment, the controller 106 performs a first-resolution scan of the complete observation area of the LIDAR system using a subset of pixels 104 of the two-dimensional array 102 to detect an object candidate using a first pixel-to-area-ratio (Block 300). The subset of pixels 104 used to perform the first-resolution scan may be changed from time to time by the controller 106, or may remain fixed. The controller 106 may also periodically activate the first subset of pixels 104 to detect new object candidates which may enter the observation area of the LIDAR system. In one embodiment, the controller 106 periodically activates the first subset of pixels 104 every 50 to 100 milliseconds to detect new object candidates which enter the observation area of the LIDAR system.

The controller 106 continues with the first-resolution scan until an object is detected (Block 302). The analysis unit 114 may confirm the presence of an object, based on the output of the photosensor 110.

The controller 106 performs a second-resolution scan of a region of the complete observation area of the LIDAR system in which the object candidate has been detected, using a second subset of the pixels 104 of the two-dimensional array 102 which emit light in the direction of the detected object candidate using a second pixel-to-area-ratio. The right-hand side of FIG. 4 shows the object candidate scan method implemented by the controller 106, whereas the left-hand side shows an exemplary scan implemented by the controller 106 at different stages in accordance with the scan method. An object candidate is illustrated as a dashed oval in the left-hand side of FIG. 4. The darkened pixels 104 in the left-hand side of FIG. 4 represent the pixels 104 illuminated by the controller 106 during different stages of the object candidate scan method.

The first-resolution scan may be performed with a relatively low pixel-to-area-ratio, e.g., every 10th pixel 104 in the two-dimensional array 102, every 20th pixel 104 in the two-dimensional array 102, every 30th pixel 104 in the two-dimensional array 102, etc. The pixels 104 in the two-dimensional array 102 used during the first-resolution scan cover the complete observation area of the LIDAR system, but with low resolution. This is illustrated by the pixel scenario labelled ‘A’ in the left-hand side of FIG. 4, where the lower-resolution scan covers the complete observation area of the LIDAR system. This way, an object candidate can be detected somewhere in the complete observation area of the LIDAR system without consuming excessive power by having to illuminate all of the pixels 104. If a candidate object is detected, the pixel-to-area-ratio in a region of the complete observation area of the LIDAR system in which the object has been detected is increased during the second-resolution scan. For example, every 3^{rd} pixel 104, every 2^{nd} pixel 104 or every pixel 104 associated with the particular region of interest may be activated by the controller 106. This is illustrated by the pixel scenario labelled ‘B’ in the left-hand side of FIG. 4, where the higher-resolution scan covers only the region of the complete observation area of the LIDAR system in which the object has been detected.

If the object candidate is confirmed as an object, e.g. by the analysis unit 114, the controller 106 may automatically adapt the second subset of pixels 104 to cover the area of a predicted movement track of the object. This is illustrated by the pixel scenario labelled ‘C’ in the left-hand side of FIG. 4, where the controller 106 uses different pixels 104 to track the higher-resolution scan based on the movement or expected movement of the detected object. This way, the LIDAR system with the pixelated light source 100 and the photosensor 110 may maintain high-resolution object tracking without having to activate more pixels 104.

Described next are various embodiments for implementing the pixelated light source and 100 the photosensor 110.

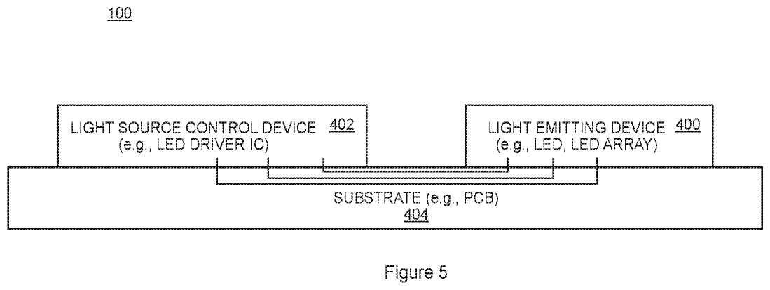

FIG. 5 illustrates an embodiment of the pixelated light source 100. The pixelated light source 100 may be implemented as a light emitting device 400 such as an array of discrete LEDs and a corresponding LED driver chip (die) or a plurality of LED driver chips 4402 for applying electrical signals to the light emitting device 400. The emitted light may be visible light, IR radiation, UV radiation, etc. The light emitting device 400 and the LED driver chip(s) 402 may be arranged in a side-by-side configuration on a substrate 404 such as a PCB (printed circuit board). Electrical chip-to-chip connections may be realized via the substrate 404.

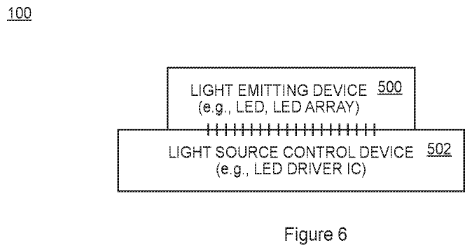

FIG. 6 illustrates another embodiment of the pixelated light source 100. The pixelated light source 100 may be implemented as a light emitting device 500 such as an array of discrete LEDs and a corresponding LED driver chip or a plurality of LED driver chips 502 for applying electrical signals to the light emitting device 500. The emitted light may be visible light, IR radiation, UV radiation, etc. The light emitting device 500 and the LED driver chip(s) 502 may be arranged in a hybrid chip-on-chip configuration. Electrical connections may be realized by a vertical chip-to-chip interface between the light emitting device 500 and the LED driver chip(s) 502.

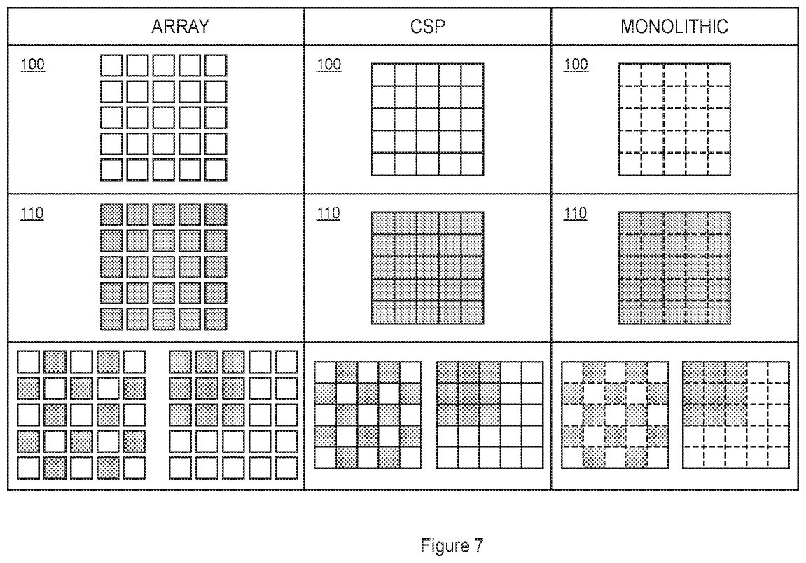

FIG. 7 illustrates various implementation embodiments for the pixelated light source 100 and the photosensor 110. The top row indicates the type of light source and photosensor physical configuration, the second row corresponds to the pixelated light source 100, the third row corresponds to the photosensor 110, and the fourth row illustrates the same exemplary pixel patterns implemented by the controller 106 for the different pixelated light source and photosensor physical configurations.

The pixelated light source 100 may be implemented as an array of discrete LEDs with a LED driver chip or a plurality of LED driver chips as shown in the first column. The pixelated light source 100 instead may be implemented as a plurality of LEDs assembled in a chip scalable package (CSP) with a LED driver chip or a plurality of LED driver chips as shown in the second column. Another option is to implement the pixelated light source 100 as a monolithic hybrid chip (LED plus driver IC) with individually controllable LED pixels as shown in the third column.

The photosensor 110 may be implemented as an array of discrete sensors as shown in the first column, as a plurality of sensors assembled in a chip scalable package (CSP) as shown in the second column, or as a monolithic hybrid chip (sensor+control IC) with individually addressable sensor pixels as shown in the third column.

The photosensor 110 and the pixelated light source 100 may be the same device. For example, the device may include a mixed array of discrete LEDs and discrete sensors with a LED driver chip (die) and a sensor control chip (die) or a multitude of LED driver chips and sensor control chips. In another example, the device may include a plurality of sensors assembled in a chip scalable package (CSP) with a LED driver chip and sensor control chip or a multitude of LED driver chips and sensor control chips. In another example, the device may include a monolithic hybrid chip (LED+driver IC) with individually controllable pixels, where the pixels may be operated in either light emission mode or in light sensing mode. The photosensor and pixelated light source embodiments described herein are not limited to visible light LED and/or photo elements. Elements emitting/sensing IR or UV wavelength or multiple wavelengths may also be used.

The methods for controlling the pixelated light source 100 and for analysing the photosensor data may be implemented in software, firmware and/or coded in hardware. The methods may be located in a computing/control unit such as a microcontroller device with peripherals, may be integrated into an LED driver chip or sensor control chip, etc.

Terms such as “first”, “second”, and the like, are used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

It is to be understood that the features of the various embodiments described herein may be combined with each other, unless specifically noted otherwise.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A light detection and ranging system, comprising:
a pixelated light source comprising a two-dimensional array of individually controllable pixels;
a controller operable to individually control each pixel of the two-dimensional array, to emit independently controlled light beams from the pixelated light source;
one or more optical components aligned with the pixelated light source and configured to direct the independently controlled light beams emitted from the pixelated light source in different directions and/or to spread the independently controlled light beams; and
a photosensor configured to detect one or more of the independently controlled light beams reflected off an object in range of the pixelated light source and in a direction toward the photosensor.

2. The light detection and ranging system of claim 1, wherein the photosensor is integrated with the pixelated light source in a same semiconductor die or in a same package.

3. The light detection and ranging system of claim 1, wherein the photosensor is realized by a subset of the individually controllable pixels of the pixelated light source which are not operated as light emitters.

4. The light detection and ranging system of claim 3, wherein the controller is operable to change the subset of individually controllable pixels used to implement the photosensor so that the pixels used for light emission and the pixels used for light detection change over time.

5. The light detection and ranging system of claim 3, wherein each pixel of the pixelated light source is operated alternately in light emission mode and light detection mode.

6. The light detection and ranging system of claim 1, wherein the photosensor is a non-pixelated single photosensor or a pixelated array of photosensors spaced apart from and aligned with the independently controlled light beams emitted from the pixelated light source.

7. The light detection and ranging system of claim 1, wherein the controller is operable to perform a first-resolution scan of a complete range of the light detection and ranging system using a subset of pixels of the two-dimensional array to detect one or more object candidates using a first pixel-to-area-ratio, and perform a second-resolution scan of a region of the complete range of the light detection and ranging system in which the one or more object candidates have been detected using a second subset of the pixels of the two-dimensional array which emit light in the direction of the one or more object candidates using a second pixel-to-area-ratio.

8. The light detection and ranging system of claim 7, wherein if one of the one or more object candidates is confirmed as the object, the second subset of pixels is automatically adapted to cover an area of a predicted movement track of the object.

9. The light detection and ranging system of claim 7, wherein the controller is operable to periodically activate the first subset of the pixels of the two-dimensional array to detect new object candidates which enter the complete range of the light detection and ranging system.

10. The light detection and ranging system of claim 9, wherein the controller is operable to periodically activate the first subset of the pixels of the two-dimensional array every 50 to 100 milliseconds to detect new object candidates which enter the range of the light detection and ranging system.

11. The light detection and ranging system of claim 1, wherein the controller is operable to simultaneously activate a subset of the pixels of the two-dimensional array to verify weak reflections or spurious signals detected by the photosensor in range or near the subset of pixels.

12. The light detection and ranging system of claim 1, further comprising an analysis unit operable to calculate a distance and/or orientation between the object and the light detection and ranging system based on the one or more of the independently controlled light beams detected by the photosensor.

13. A method of operating a light detection and ranging system which includes a photosensor and a pixelated light source comprising a two-dimensional array of individually controllable pixels, the method comprising:
individually controlling each pixel of the two-dimensional array, to emit independently controlled light beams from the pixelated light source;
directing the independently controlled light beams emitted from the pixelated light source in different directions and/or spreading the independently controlled light beams; and
detecting one or more of the independently controlled light beams reflected off an object in range of the pixelated light source and in a direction toward the photosensor.

14. The method of claim 13, further comprising:
realizing the photosensor by a subset of the individually controllable pixels of the pixelated light source which are not operated as light emitters.

15. The method of claim 14, further comprising:
changing the subset of individually controllable pixels used to implement the photosensor so that the pixels used for light emission and the pixels used for light detection change over time.

16. The method of claim 15, wherein changing the subset of individually controllable pixels used to implement the photosensor comprises:
operating each pixel of the pixelated light source alternately in light emission mode and light detection mode.

17. The method of claim 13, further comprising:
performing a first-resolution scan of the complete range of the light detection and ranging system using a subset of pixels of the two-dimensional array to detect an object candidate using a first pixel-to-area-ratio; and
performing a second-resolution scan of a region of the complete range of the light detection and ranging system in which the object candidate has been detected using a second subset of the pixels of the two-dimensional array which emit light in the direction of the object candidate using a second pixel-to-area-ratio.

18. The method of claim 17, further comprising:
periodically activating the first subset of the pixels of the two-dimensional array to detect new object candidates which enter the range of the light detection and ranging system.

19. The method of claim 13, further comprising:
simultaneously activating a subset of the pixels of the two-dimensional array to verify weak reflections or spurious signals detected by the photosensor in range or near the subset of pixels.

20. The method of claim 13, further comprising:
calculating a distance between the object and the light detection and ranging system based on the one or more of the independently controlled light beams detected by the photosensor.
